(19) United States
(12) Patent Application Publication
(10) Pub. No.: US 2007/0224388 A1
(43) Pub. Date: Sep. 27, 2007

(54) Composite plastic part

(75) Inventor: Frank Born, Dienethal (DE)

Correspondence Address: COHEN, PONTANI, LIEBERMAN & PAVANE, 551 FIFTH AVENUE, SUITE 1210, NEW YORK, NY, 10176, US

(73) Assignee: Stabilus GmbH, Koblenz (DE)

(21) Appl. No.: 11/726,250

(22) Filed: Mar. 21, 2007

(30) Foreign Application Priority Data
Mar. 21, 2006 (DE) 10 2006 014 548.8

(51) Int. Cl. B29C 45/14; B32B 3/06

(52) U.S. Cl. 428/100; 264/279; 264/279.1; 428/375

(57) ABSTRACT

A composite plastic part with reinforcing elements embedded in a plastic mass, wherein the reinforcing elements have a structure which makes it possible for the reinforcing elements to become effectively connected to each other mechanically in all spatial directions.

The invention pertains to a composite plastic part, especially an injection-molded part, with reinforcing elements embedded in a plastic mass. The invention also pertains to a process for the production of reinforcing elements for a composite plastic part of this type. The invention also pertains to a process for the production of the previously described composite plastic part.

The plastic mass forms a matrix, in which the reinforcing elements are embedded. In the case of conventional composite plastic parts, the attempt is made to obtain high strength by ensuring good adhesion between the reinforcing elements and the matrix. In addition, in the case of laminated plastics, for example, a fabric is embedded in the plastic mass. In the case of injection-molded parts with reinforcing elements, the strength depends on the orientation of the reinforcing elements. When fibers are used as reinforcing elements in the case of injection-molding, the fibers orient themselves in the flow direction of the molding compound during the injection process. The strength transverse to the flow direction is much lower than that in the flow direction.

The task of the invention is to create a composite plastic part, especially an injection-molded part, with reinforcing elements embedded in a plastic mass, this new part having greater strength than conventional parts.

For a composite plastic part, especially an injection-molded part, with reinforcing elements embedded in a plastic mass, the task is accomplished in that the reinforcing elements have a structure which makes it possible for the reinforcing elements to become effectively connected to each other mechanically in all spatial directions. The reinforcing elements are preferably made and dimensioned in such a way that they can be processed by injection-molding. Through the structure of the reinforcing elements, the goal is achieved that the reinforcing elements interlock with each other in the plastic mass in such a way that a spatial reinforcement structure is created.

A preferred exemplary embodiment of the composite plastic part is characterized in that the reinforcing elements, or at least some of them, have a hook-like structure. The reinforcing elements are preferably fibers. Through the hook-like structure of the fibers, the goal is achieved that the reinforcing elements hook onto each other in all spatial directions.

Another preferred exemplary embodiment of the inventive composite plastic part is characterized in that the ends of the reinforcing elements are curved into a hook-like shape. The ends of the reinforcing elements can have various radii of curvature.

Another preferred exemplary embodiment of the composite plastic part is characterized in that the reinforcing elements, or at least some of them, have a spiral structure. The reinforcing elements preferably have the shape of helical springs. As a result, the reinforcing elements can easily hook onto each other. In addition, the spiral-shaped structure provides a large number of opportunities for reinforcing elements of a different design to hook onto them.

Another preferred exemplary embodiment of the composite plastic part is characterized in that the reinforcing elements, or at least some of them, have a C-shaped structure. The C-shaped structure preferably has the form of an elliptical arc.

Another preferred exemplary embodiment of the composite plastic part is characterized in that the C-shaped structure has a smaller radius of curvature at the ends than it does in the section between the ends. The radius of curvature between the ends can also be infinite, which means that a straight line is obtained.

Another preferred exemplary embodiment of the composite plastic part is characterized in that the reinforcing elements, or at least some of them, are made of a dimensionally stable material. As a result, a stable spatial reinforcement structure is created.

Another preferred exemplary embodiment of the composite plastic part is characterized in that the reinforcing elements, or at least some of them, are made out of a flexible material. As a result, processing is made easier.

Another preferred exemplary embodiment of the composite plastic part is characterized in that the reinforcing elements contain glass fibers and/or mineral fibers and/or plastic fibers. The mineral fibers can be, for example, carbon fibers.

A process for the production of reinforcing elements for a previously described composite plastic part, especially an injection-molded part, is characterized in that the reinforcing elements are made out a material, especially a plastic material or a plastic-containing material, which is capable of “remembering the structure which makes it possible for the reinforcing elements to become effectively connected mechanically with each other in all spatial directions. This memory capacity is also called the “memory effect”. It is an effect related to entropy elasticity.

A preferred exemplary embodiment of the process is characterized in that the reinforcing elements are first provided with the desired structure and then frozen into a structureless state, and in that they assume their original structure again when heated. The reinforcing elements are, for example, provided with the desired structure by a shaping method such as injection-molding or extrusion. Because the structure may have the effect of interfering with further processing, the reinforcing elements are brought into a preferably stretched-out state before further processing. After or during further processing, the structure is reactivated preferably by heating. It is also possible within the scope of the present invention, however, to use reinforcing elements which permanently retain the structure which is given them during, for example, the shape-forming process.

The invention also pertains to a process for the production of a previously described composite plastic part, especially an injection-molded part, in which reinforcing elements are added to a plastic mass, the reinforcing elements having a structure which makes it possible for the reinforcing elements to become effectively connected mechanically to each other in all spatial directions.

Additional advantages, features, and details of the invention can be derived from the following description, in which various exemplary embodiments are described in detail with reference to the drawings.

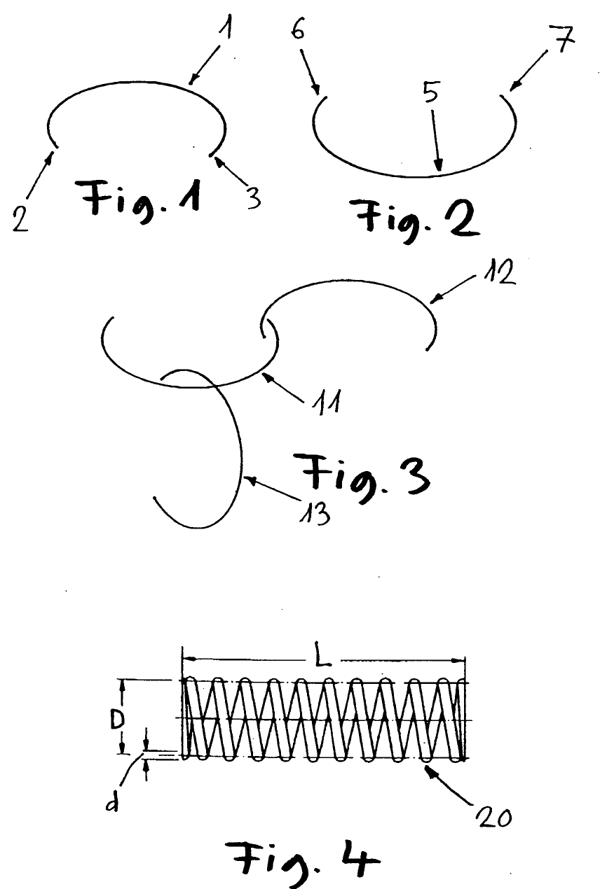

FIG. 1 shows a schematic plan view of a reinforcing element according to a first exemplary embodiment;

FIG. 2 shows a reinforcing element similar to that of FIG. 1 from another direction;

FIG. 3 shows three reinforcing elements like those shown in FIGS. 1 and 2, the elements being hooked together to a certain extent; and

FIG. 4 shows a plan view of a reinforcing element according to another exemplary embodiment.

The invention pertains to plastic composite systems with a matrix of plastic, in which reinforcing elements are embedded. According to an essential aspect of the invention, the reinforcing elements have a structure or geometry which makes it possible for the reinforcing elements to become hooked together with each other.

FIG. 1 shows a reinforcing element 1, which is curved into the shape of a “C”. The reinforcing element 1 has two ends 2, 3, which are facing toward each other. Between the two ends, the reinforcing element 1 is not curved as sharply as at the ends themselves.

FIG. 2 shows a reinforcing element 5 similar to that of FIG. 1. The reinforcing element 5 has two facing ends 6, 7. In comparison to the exemplary embodiment shown in FIG. 1, the reinforcing element 5 is somewhat larger. In addition, the two ends 6, 7 are pointing upward.

FIG. 3 shows three reinforcing elements 11, 12, 13, which are hooked together to a certain extent. One end of the reinforcing element 11 is hooked onto an end of the reinforcing element 12. One end of the reinforcing element 13 is hooked onto the central area of the reinforcing element 11. In FIG. 3, it becomes obvious that the inventive reinforcing elements make it possible to provide reinforcement in all spatial directions. The ends of the reinforcing elements can be curved in any desired direction.

FIG. 4 shows a plan view of a spiral reinforcing element 20, which has the shape of a helical spring with a length L and a turn diameter D. The reinforcing element 20 is formed by a fiber, which has been wound into a helix. The thickness of the fiber in FIG. 4 is designated by the symbol “d”. The spiral form offers the advantage that the turns offer a large number of possible hooking sites onto which similarly shaped reinforcing elements or reinforcing elements such as those shown in FIGS. 1-3 can become hooked.

The reinforcing elements illustrated in FIGS. 1-4 are preferably short fibers. Within the scope of the present invention, preferably glass and mineral fibers are used. In the case of the exemplary embodiment shown in FIG. 4, it is also possible to use long fibers. Plastic fibers can be used in all of the exemplary embodiments. When the reinforcing elements are being shaped, the principle of the shape memory effect, for example, can be utilized. The shape memory effect is activated, for example, by heating, so that the reinforcing elements assume the inventive shape, i.e., the shape which they were given originally by mechanical shaping, for example, after they have been in contact with the hot plastic molding compound for a certain length of time.

### LIST OF REFERENCE NUMBERS

1 reinforcing element
2 end
3 end
5 reinforcing element
6 end
7 end
11 reinforcing element
12 reinforcing element
13 reinforcing element
20 reinforcing element
L length
D diameter of the turns
d fiber diameter

1-12. (canceled)

13. A composite plastic part comprising reinforcing elements embedded in a plastic mass, wherein the reinforcing elements have a structure which makes it possible for the reinforcing elements to become effectively connected to each other mechanically in all spatial directions.

14. The composite plastic part of claim 13, wherein at least some of the reinforcing elements have a hook-like structure.

15. The composite plastic part of claim 14, wherein the hook-like reinforcing elements have ends that are curved into a hook-like shape.

16. The composite plastic part of claim 13, wherein at least some of the reinforcing elements have a helical structure.

17. The composite plastic part of claim 13, wherein at least some of the reinforcing elements have a C-shaped structure.

18. The composite plastic part of claim 17, wherein the C-shaped structure has opposite ends and an intermediate portion connecting the ends, the ends having a smaller radius of curvature than the intermediate portion.

19. The composite plastic of claim 13, wherein at least some of the reinforcing elements are made of a dimensionally stable material.

20. The composite plastic part of claim 13, wherein at least some of the reinforcing elements are made of a flexible material.

21. The composite plastic part of claim 13, wherein the reinforcing elements contain at least one of glass fibers, mineral fibers, and plastic fibers.

22. The composite plastic part of claim 13, wherein said composite part is an injection-molded part.

23. A process for the production of reinforcing elements for a composite plastic part comprising reinforcing elements embedded in a plastic mass, wherein the reinforcing elements are formed of one of a plastic material and a plastic-containing material having a memory for structure which makes it possible for the reinforcing elements to become effectively connected mechanically to each other in all spatial directions.

24. The process according to claim 23, wherein the reinforcing elements are first provided with the desired structure and then frozen into a structureless state, so that they can assume their original structure again when heated.

25. A process for the production of a composite plastic part comprising reinforcing elements embedded in a plastic mass, wherein reinforcing elements are added to a plastic molding compound, the reinforcing elements having a structure which makes it possible for the reinforcing elements to become effectively connected to each other mechanically in all spatial directions.
